(19) United States
(12) Patent Application Publication
(10) Pub. No.: US 2015/0154438 A1
(43) Pub. Date: Jun. 4, 2015

(54) METHOD FOR PROCESSING INFORMATION, INFORMATION PROCESSOR, AND COMPUTER PROGRAM PRODUCT

(71) Applicant: Kabushiki Kaisha Toshiba, Tokyo (JP)

(72) Inventors: Yoshikata TOBITA, Tokyo (JP); Tomoyuki HARADA, Tokyo (JP); Akinobu IGARASHI, Tokyo (JP); Tetsuya MASHIMO, Tokyo (JP)

(21) Appl. No.: 14/464,143

(22) Filed: Aug. 20, 2014

(30) Foreign Application Priority Data
Dec. 2, 2013 (JP) 2013-249666

(51) Int. Cl. G06K 9/00

(52) U.S. Cl. CPC G06K 9/00221

(57) ABSTRACT

According to one embodiment, a method is for processing information using a processor. The method includes: regrouping images from at least a first group of first images and a second group of second images into a third group comprising at least one first image and at least one second image; and setting third setting information for the third group based upon first setting information set for the first group and second setting information set for the second group.

### CROSS-REFERENCE TO RELATED APPLICATIONS

This application is based upon and claims the benefit of priority from Japanese Patent Application No. 2013-249666, filed Dec. 2, 2013, the entire contents of which are incorporated herein by reference.

### FIELD

Embodiments described herein relate generally to a method for processing information, an information processor, and a computer program product.

### BACKGROUND

There has been disclosed a technique in which face images comprised in a plurality of images are detected and classified into some groups based on the similarity of characteristics of the detected face images.

If various types of settings have been made for the groups and a regrouping is performed, however, settings for the groups after the regrouping need to be set again.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic external view of an information processor according to an embodiment;

FIG. 2 is an exemplary block diagram of a hardware configuration of the information processor in the embodiment;

FIG. 3 is an exemplary block diagram of a functional configuration of the information processor in the embodiment;

FIG. 4 is an exemplary diagram of a content data table stored in the information processor in the embodiment;

FIG. 5 is an exemplary diagram of an object data table stored in the information processor in the embodiment;

FIG. 6 is an exemplary diagram of a setting screen displayed by the information processor in the embodiment;

FIG. 7 is an exemplary diagram of a selection screen displayed by the information processor in the embodiment; and

FIG. 8 is an exemplary flowchart of a process for setting for group setting information in the information processor in the embodiment.

### DETAILED DESCRIPTION

In general, according to one embodiment, a method is for processing information using a processor. The method comprises: regrouping images from at least a first group of first images and a second group of second images into a third group comprising at least one first image and at least one second image; and setting third setting information for the third group based upon first setting information set for the first group and second setting information set for the second group.

Hereinafter, a method for processing information, an information processor, and an information processing program according to the embodiment will be described with reference to the accompanying drawings.

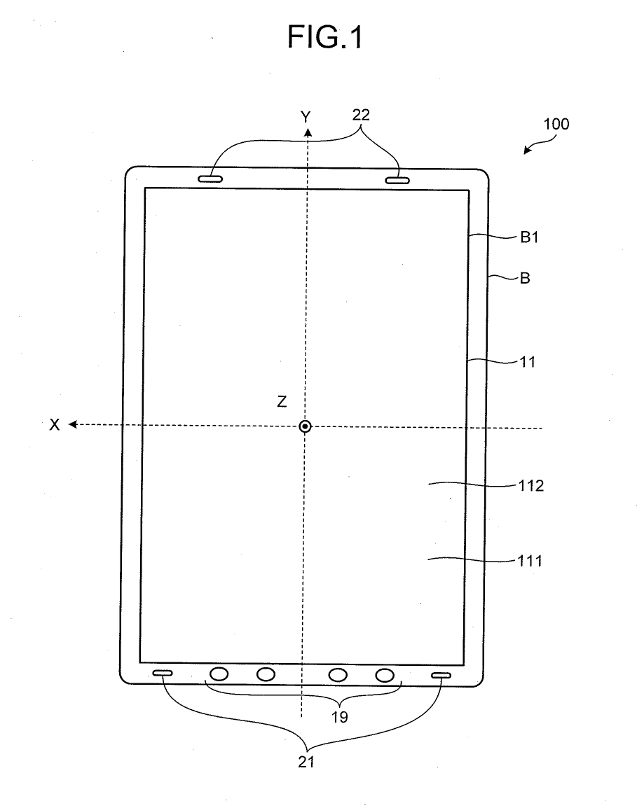

FIG. 1 is a schematic external view of an information processor according to an embodiment. This information processor 100 according to the embodiment is achieved with a tablet terminal, and a digital photo frame, for example. Specifically, as illustrated in FIG. 1, the information processor 100 comprises a housing B in a slate shape that houses a display 11. The housing B in the embodiment comprises a face (hereinafter, referred to as an upper face) comprising an opening B1 that exposes a display screen 112 comprised in the display 11.

The display 11 comprises: a display screen 112 capable of displaying various types of information; and a touch panel 111 provided on the display screen 112 and detecting a position touched by a user on the display screen 112. Operating switches 19 and microphones 21 are provided on the lower part of the upper face of the housing B. The operating switches 19 are used for various types of operations by a user and the microphones 21 are used for capturing a user's voice. Speakers 22 are provided on the upper portion of the upper face of the housing B, which outputs audio from the information processor 100.

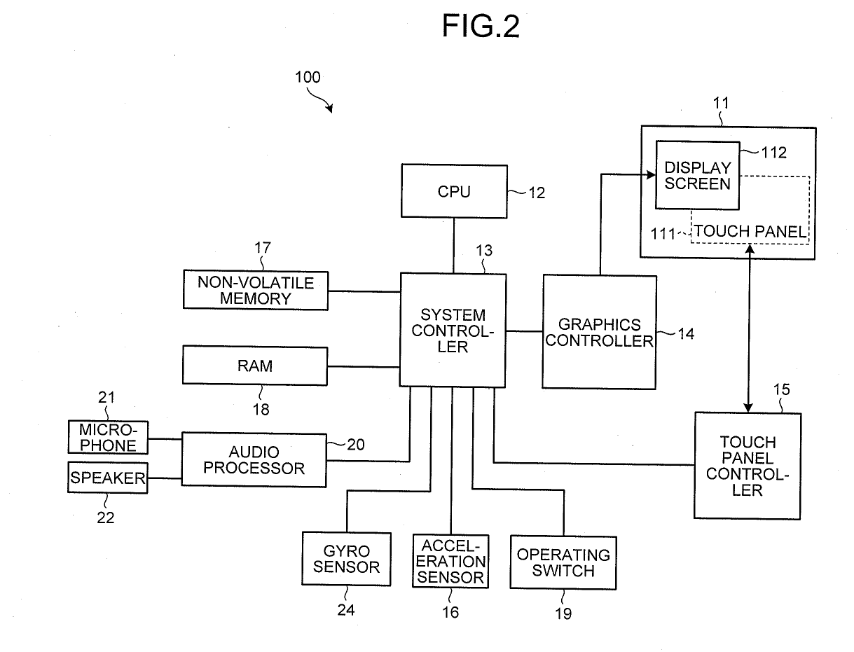

FIG. 2 is a block diagram of a hardware configuration of the information processor according to the embodiment. As illustrated in FIG. 2, the information processor 100 in the embodiment comprises a central processing unit (CPU) 12, a system controller 13, a graphics controller 14, a touch panel controller 15, an acceleration sensor 16, a non-volatile memory 17, a random access memory (RAM) 18, an audio processor 20, and a gyro sensor 24 in addition to the components described above.

The display 11 comprises: the touch panel 111; and the display screen 112 comprising a liquid crystal display (LCD), an organic light emitting display (OLED), or the like. The touch panel 111 is provided on the display screen 112 and serves as a coordinate sensor, for example. The touch panel 111 detects a position on the display screen 112 touched with a finger of a user grasping the housing B (a touched position).

The CPU 12 is a processor for controlling the modules and portions in the information processor 100 through the system controller 13. The CPU 12 executes an operating system, a web browser, and various computer application programs such as a software program used for writing, loaded from the non-volatile memory 17 to the RAM 18.

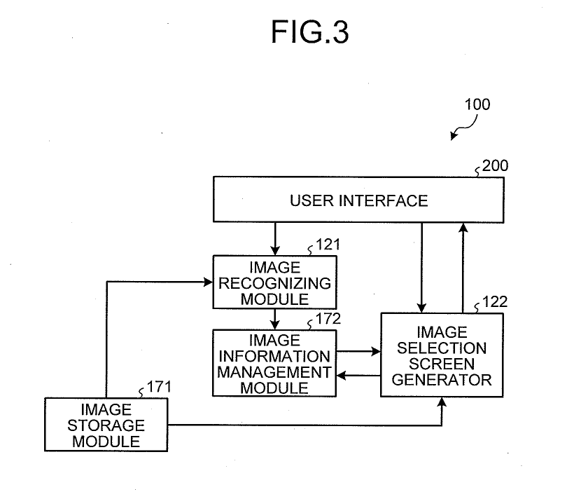

The non-volatile memory 17 stores therein various computer application programs and various types of data. In the present embodiment, the non-volatile memory 17 functions as an image storage module 171 and an image information management module 172 (refer to FIG. 3). The image storage module 171 stores therein an image to be displayed on the display screen 112 (in other words, a candidate for display) (e.g., an image acquired with a camera, not illustrated, comprised in the information processor 100, or an image input from an external device). The image information management module 172 stores therein image-related information related to an image stored in the image storage module 171. The RAM 18 provides a working area for the CPU 12 to execute a computer program.

The system controller 13 comprises therein a memory controller that accesses the non-volatile memory 17 and the RAM 18, and controls them. The system controller 13 comprises a function to communicate with the graphics controller 14.

The graphics controller 14 serves as a display controller, and controls the display screen 112. The touch panel controller 15 controls the touch panel 111, and obtains therefrom the coordinate data indicating the touched position by a user on the display screen 112.

The gyro sensor 24 detects a rotation angle when the information processor 100 rotates around the X-axis, the Y-axis, or the Z-axis. The gyro sensor 24 then outputs a rotational angle signal that indicates the rotation angle around the X-axis, the Y-axis, or the Z-axis to the CPU 12.

The acceleration sensor 16 detects accelerations of the information processor 100. The acceleration sensor 16 in the embodiment detects the accelerations in the directions of the X-axis, the Y-axis, and the Z-axis illustrated in FIG. 1, and the accelerations in the rotational directions around the X-axis, the Y-axis, and the Z-axis. The acceleration sensor 16 then outputs to the CPU 12 an acceleration signal indicating the accelerations in the directions of the X-axis, the Y-axis, and the Z-axis illustrated in FIG. 1, and the accelerations in the rotational direction around the X-axis, the Y-axis, and the Z-axis.

The audio processor 20 executes audio processing such as digital conversion, noise removal, and echo cancellation on an audio signal input from the microphone 21, and outputs the resulting signal to the CPU 12. The audio processor 20 also outputs to the speaker 22 the audio signal generated through audio processing such as audio composition under the control of the CPU 12.

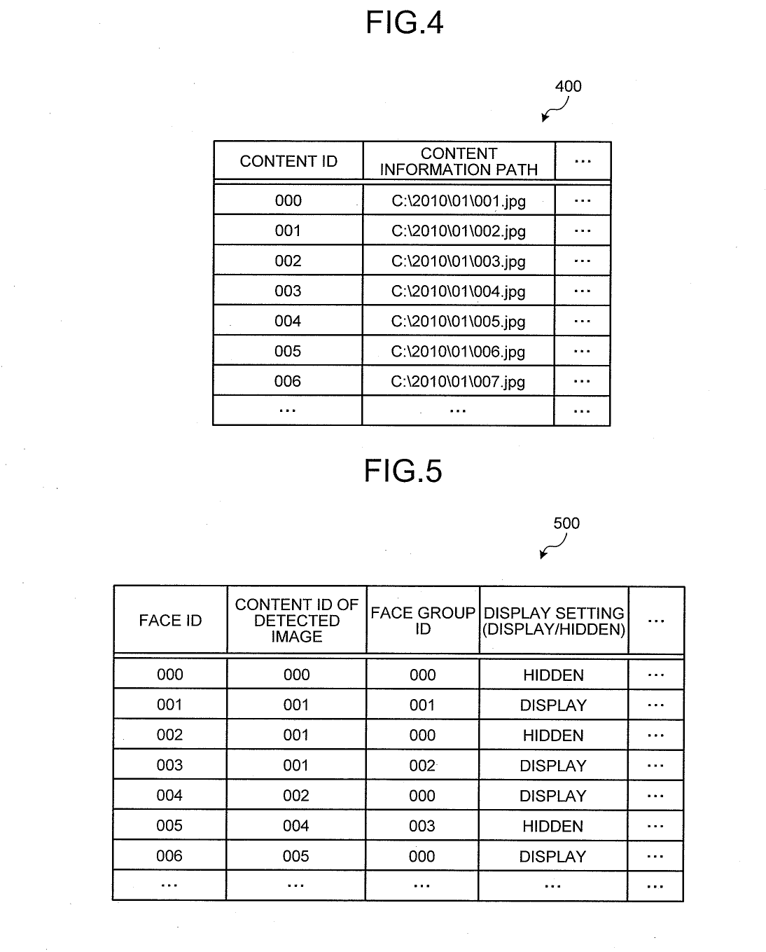

The following describes a functional configuration of the information processor 100 in the embodiment with reference to FIGS. 3 to 5. FIG. 3 is a block diagram of the functional configuration of the information processor according to the embodiment. FIG. 4 is a diagram of a content data table stored in the information processor according to the embodiment. FIG. 5 is a diagram of an object data table stored in the information processor according to the embodiment.

As illustrated in FIG. 3, the CPU 12 executes a computer program stored in the non-volatile memory 17 so as to implement an image recognizing module 121 and an image selection screen generator 122 in the information processor 100. The touch panel 111 functions as a user interface 200 used by a user for inputting various types of operations to the information processor 100 in the present embodiment. The non-volatile memory 17 functions as the image storage module 171 and the image information management module 172 in the present embodiment. The image storage module 171 stores therein an image to be displayed on the display screen 112, and the image information management module 172 stores therein image-related information related to an image stored in the image storage module 171.

If a user instructs through the interface 200 the recognition of an image (content information) stored in the image storage module 171, the image recognizing module 121 stores a content data table 400 (refer to FIG. 4) as the image-related information in the image information management module 172. The content data table 400 associates a content ID for identifying each image stored in the image storage module 171 with a content information path indicating the place where the image identified with the content ID is stored; and meta data (an example of setting information determined for the image in advance) of the image identified with the content ID. The meta data in the present embodiment comprises an image size; an imported time and date on which the image is imported from an external device; and if the image has been acquired with a camera not illustrated, the image-acquiring conditions of the acquired image (the place where the image is acquired, the time and date when the image is acquired, and the person who acquired the image).

The image recognizing module 121 then classifies the images each identified with the content ID in the content data table 400 into two groups: a first group comprising a first image and a second group comprising a second image. In the description below, the images each identified with the content ID in the content data table 400 are classified into two groups, (the first group and the second group), however, they may be classified into three or more groups. The image recognizing module 121 can classify an image into one or more groups. Specifically, the image recognizing module 121 firstly detects an object (an object image) from each image identified with the content ID in the content data table 400. If the image identified with the content ID in the content data table 400 is acquired with a camera not illustrated, the image recognizing module 121 detects a subject acquired with the camera not illustrated (e.g., a face image) as an object.

Subsequently, the image recognizing module 121 classifies the images into one or more groups based on the object detected from the image. Specifically, the image recognizing module 121 classifies images comprising an object similar to the above-described object into one group for each object detected from the respective images. This enables the image recognizing module 121, if the image recognizing module 121 detects a plurality of objects from an image, to classify an identical image into groups by classifying the identical image into groups each comprising each of detected objects.

In the present embodiment, the image recognizing module 121 classifies an image or images into one or more groups according to the similarity of an object or objects comprised in each image. However, this is provided merely for exemplary purpose and is not limiting. The image recognizing module 121 may classify an image or images into one or more groups according to meta data of an image or image setting information of an image determined for an object in advance (refer to FIG. 5).

If a new image is stored in the image storage module 171, if an image is deleted from the image storage module 171, or if a user instructs through the user interface 200 execution of processing for regrouping a plurality of images that have been already classified into groups, the image recognizing module 121 (an example of a classifying module) executes a process for regrouping the images each identified with the content ID in the content data table 400 (i.e., the first image comprised in the first group and the second image comprised in the second group) into a third group comprising at least one of the first images comprised in the first group and at least one of the second images comprised in the second group.

The method for the regrouping process may be the same as the classifying method previously used (e.g., a method for classifying an image or images into one or more groups according to the similarity of an object or objects in the images). Alternatively, the method for the regrouping process may be a different method from the classifying method previously used (e.g., a method for classifying an image or images into one or more groups according to meta data of an image or image setting information of the image determined for the image in advance (refer to FIG. 5).

If the image recognizing module 121, however, executes the regrouping process with the same method for classifying images into groups as the previously used method, without storing a new image in the image storage module 171 or deleting the image from the image storage module 171, the same combination of images may be classified into the same group as a previous time. To cope with this, the image recognizing module 121 uses a different method from the classifying method previously used. This enables the image recognizing module 121 to reclassify the images comprised in the groups into a plurality of groups, each comprising different combination of images as previously classified.

The image recognizing module 121 also determines various types of image setting information such as a display setting (in the present embodiment, if display of an image on the display 11 is permitted “display” is set, and if display of an image on the display 11 is prohibited “hidden” is set), that is an example of setting information indicating whether the image can be displayed on the display 11, for each image comprised in the groups (for at least one of the first images comprised in the first group and at least one of the second images comprised in the second group, respectively). As illustrated in FIG. 5, the image recognizing module 121 then stores an object data table 500 as image-related information in the image information management module 172. The object data table 500 associates a face ID used for identifying an object (e.g., a face image) detected from an image; a content ID (hereinafter, referred to as a content ID of detected image) of an image (the content information) from which the object is detected with the face ID; a face group ID for identifying a group into which the image identified with the content ID of detected image and the image setting information that is an example of setting information determined for the image identified with the content ID of detected image, with each other.

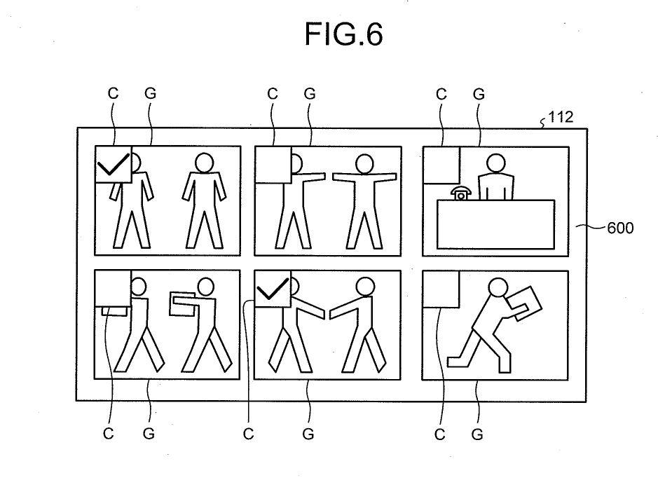

In the present embodiment, the image setting information comprises the display setting, the hue, the sharpness, the scene and season when the image is acquired, object information (e.g., face images, plants and animals, buildings, and logo marks) of an object comprised in the image, the gender, the age, the degree of smile of a person (an example of objects) comprised in the image, of the image identified with the content ID of detected image. In the present embodiment, the image recognizing module 121 sets “display” for the display setting comprised in the image setting information in the initial state when images are classified into groups, in other words, before the display setting is changed through a setting screen 600 described later (refer to FIG. 6).

If images are classified into groups, the image recognizing module 121 determines, for each of the groups, information that is based on the image setting information (or the meta data) set for at least one of the images comprised in the each of the groups as the group setting information of the each of the groups (an example of first setting information and second setting information). The group setting information is, for example, information for determining a process on the images comprised in the group, or information of the setting state of the setting information set for the images comprised in the group. In the same manner, the image recognizing module 121 (an example of a setting module) also sets the group setting information (an example of third setting information) of the group for the group after the regrouping process (an example of the third group) by using the group setting information (the first setting information and the second setting information) set for the group before the regrouping process (an example of the first group and the second group). In other words, the image recognizing module 121 determines, for the regrouped group, the information that is based on the image setting information (or the meta data) of at least one of the images comprised in the regrouped group, as the group setting information of the regrouped group. In the present embodiment, the image recognizing module 121 determines information obtained by summarizing the image setting information (or the meta data) of at least one of the images comprised in the regrouped group as the group setting information of the regrouped group. As a result, the image setting information (or the meta data) of the at least one of the images comprised in each regrouped group is treated as group setting information of the each regrouped group, thereby dynamically changing the group setting information of a group if the regrouping process is executed. This eliminates the necessity of resetting the group setting information on the group if the regrouping process is executed.

In the present embodiment, if the display setting set for at least one of the images comprised in the group (an example of the third group), on which the group setting information is set, indicates “display”, the image recognizing module 121 determines the group setting information so that the image comprised in the group to be set can be displayed. If the display setting set for the at least one of the images comprised in the group (an example of the third group), on which the group setting information is set, indicates “hidden”, the image recognizing module 121 determines the group setting information so that the image comprised in the group to be set cannot be displayed. That is, if the display setting comprised in the image setting information of at least one of the images comprised in the group, on which the group setting information is set, indicates “display”, the image recognizing module 121 determines the group setting information so as to permit display of the image. If the display setting set for all of the images comprised in the group, on which the group setting information is set, indicates “hidden”, the image recognizing module 121 determines the group setting information so as to prohibit display of the image comprised in the group to be set.

In the present embodiment, the image recognizing module 121 sets the group setting information of the groups by using the content data table 400 and the object data table 500 stored in the image information management module 172. A setting process of the group setting information will be described later in detail.

If a user instructs through the interface 200 the change of the display setting of each image comprised in the groups, the image selection screen generator 122 causes, for each of the groups, the setting screen for changing the display setting of each image comprised in the group to be displayed on a display screen 112 on the display 11.

FIG. 6 is a diagram of the setting screen displayed by the information processor according to the embodiment. As illustrated in FIG. 6, if a user instructs through the interface 200 the change of the display setting of each image comprised in the groups, the image selection screen generator 122 displays on the display screen 112, for each of the groups, a setting screen 600 comprising an image G comprised in each group and a checkbox C for each image G. The user can change the display setting for the image G through the checkbox C. The user of the information processor 100 changes the state of the checkbox C for each image G between selected and unselected states through the user interface 200.

The above-described image recognizing module 121 changes the display setting to “display”, which is comprised in the image setting information of the image G of which checkbox C is selected out of the images G classified in the group displayed on the setting screen 600. By contrast, the image recognizing module 121 changes the display setting to “hidden”, which is comprised in the image setting information of the image G of which checkbox C is selected out of the images G classified in the groups displayed on the setting screen 600. This enables the image recognizing module 121, as illustrated in FIG. 5, to have different display settings of the face group IDs (e.g., “001”, “000”, and “002”) associated with an identical content ID of detected image.

The image selection screen generator 122 (an example of display controllers) also generates a representative image (in the present embodiment, an image used for instructing to display the image comprised in the group) representing the images in the group, on which the group setting information has been set, which indicates that display of the image is permitted. The image selection screen generator 122 then displays the generated representative image on the display 11. Specifically, the image selection screen generator 122 generates a representative image for the group comprising the group setting information indicating that display of the image is permitted, according to an image of which display setting indicates “display” (hereinafter, referred to as an image for display) out of the images comprised in the group. By contrast, the image selection screen generator 122 generates a representative image for the group comprising the group setting information indicating that display of the image is prohibited, according to the images comprised in the group.

In the present embodiment, if an instruction to generate a selection screen comprising a representative image of a group is provided through the user interface 200, the image selection screen generator 122 generates a representative image for a group having group setting information indicating that displaying is permitted. Here, the representative image is one of objects (e.g., face images) detected from the images for display comprised in the group and satisfies a predetermined selection condition. By contrast, the image selection screen generator 122 generates a representative image for a group having group setting information indicating that displaying is prohibited. Here, the representative image is one of objects detected from the images comprised in the group and satisfies a predetermined selection condition.

The predetermined selection conditions are conditions for selecting an object suitable as a representative image. For example, the condition may be satisfied if an object is selected from an image associated with the oldest image acquiring date and time contained in the metadata of the content data table 400. Further, the condition may be satisfied if an object is contained in an image for display associated with the highest degree of smile of a person or the highest sharpness contained in the image setting information in the object data table 500.

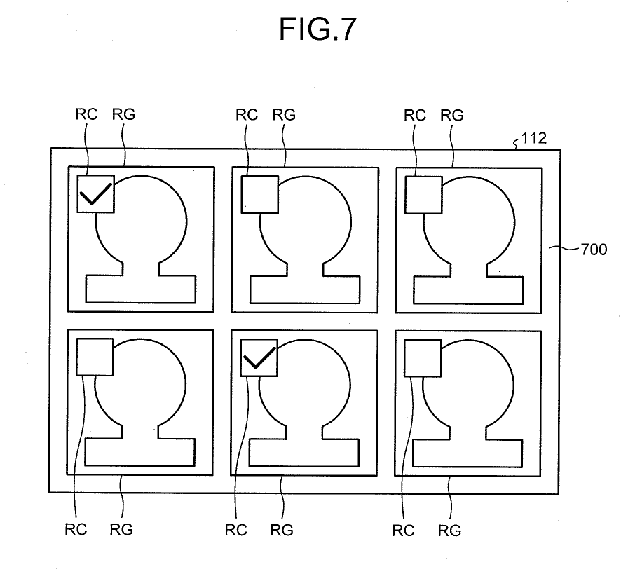

If representative images are generated for all of the groups, the image selection screen generator 122 displays on the display screen 112 of the display 11 the selection screen comprising representative images for all of the groups disposed thereon. FIG. 7 is a diagram of the selection screen displayed by the information processor according to the embodiment. In the present embodiment, as illustrated in FIG. 7, the image selection screen generator 122 displays on the display screen 112 of the display 11 a selection screen 700 comprising representative images RG for all of the groups disposed thereon and a checkbox RC for each image RG. The checkbox RC indicates whether display of the image is permitted in the group setting information in each of the groups.

If the group setting information set for the group corresponding to the representative image RG indicates that display of the image is permitted, the image selection screen generator 122 makes the checkbox RC of the representative image RG to be selected. If the group setting information set for the group corresponding to the representative image RG indicates that display of the image is prohibited, the image selection screen generator 122 makes the checkbox RC of the representative image RG to be unselected.

If a user changes through the interface 200 the state of the checkbox RC from the selected state to the unselected state (i.e., if the group setting information is input indicating that display of the images comprised in the group is prohibited), in the object data table 500, the display settings are changed to “hidden”, which are associated with the content IDs of detected image for all of the images comprised in the group corresponding to the representative image RG of which checkbox RC is changed to the unselected state.

If a user changes through the interface 200 the state of the checkbox RC from the unselected state to the selected state (i.e., if the group setting information is input indicating that display of the images comprised in the group is permitted), in the object data table 500, the display settings are changed to “display”, which are associated with the content IDs of detected image for all of the images comprised in the group corresponding to the representative image RG of which checkbox RC is changed to the selected state.

That is, if the group setting information is input, the image recognizing module 121 changes the image setting information of the image comprised in the group, on which the input group setting information is set, according to the input group setting information. This enables the user to change the image setting information set for each of the images comprised in the group, on which the group setting information has been set, by merely changing the group setting information. This eliminates the necessity of resetting the image setting information for the respective images.

In the present embodiment, the image selection screen generator 122 can distinguish the group, on which the group setting information indicating that display of the image is permitted is set, from the group, on which the group setting information indicating that display of the image is prohibited is set, by making the state of the checkbox RC to the selected state or the unselected state. However, this is provided merely for exemplary purpose and not limiting. The image selection screen generator 122 may hide or gray out the representative image RG, thereby providing different display aspects between the group, on which the group setting information indicating that display of the image is permitted is set, and the group, on which the group setting information indicating that display of the image is prohibited is set.

If a user selects the representative image (the representative image RG of which checkbox RC is selected in FIG. 7) corresponding to the group, on which the group setting information indicating that display of the image is permitted, out of the representative images disposed on the displayed selection screen on the display screen 112, the image selection screen generator 122 displays on the display screen 112 of the display 11 the image comprised in the group corresponding to the selected representative image (the image for display). This enables the user of the information processor 100 to view, for each of the groups, the images for display out of the images comprised in the group.

In the present embodiment, the image selection screen generator 122 generates the representative image with an object (e.g., a face image) comprised in the image for display in the groups. However, this is provided merely for exemplary purpose and is not limiting. For example, the image selection screen generator 122 may generate the representative image of the entire image for display comprised in the groups, or an image comprising a plurality of images for display comprised in the groups.

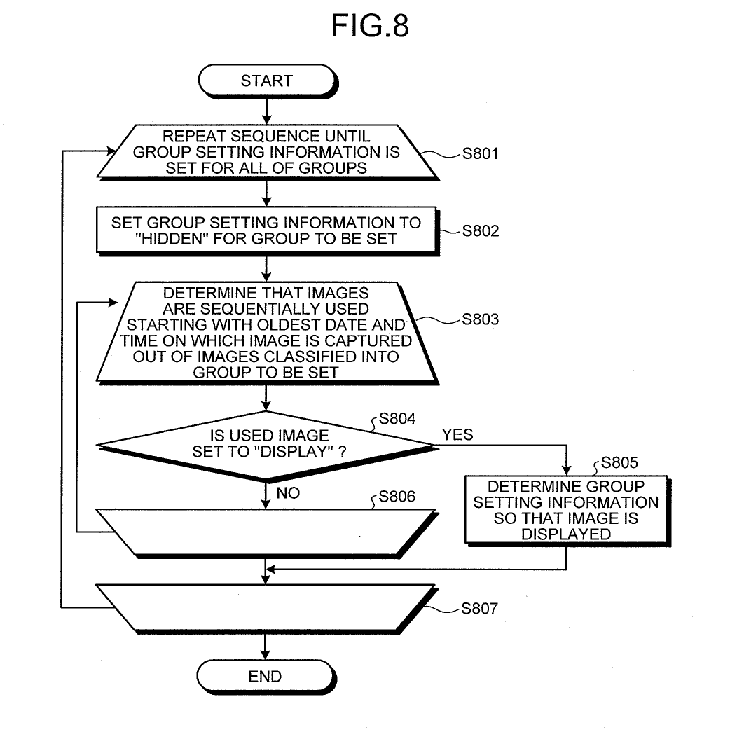

The following describes in detail a setting process on the group setting information executed by the information processor 100 according to the present embodiment with reference to FIG. 8. FIG. 8 is a flowchart of a process for setting for the group setting information in the information processor according to the embodiment.

If the image recognizing module 121 classifies a plurality of images into a plurality of groups, or executes the regrouping process, the image recognizing module 121 repeats the following process (S802 to S807) for each of the groups until the group setting information is set for all of the groups (S801).

First, the image recognizing module 121 initializes group setting information of at least one of the groups, which is a target for setting the group setting information (S802). Here, the group setting information of the at least one of the groups is initialized such that an image contained in the at least one of the groups is prohibited from displaying.

Next, the image recognizing module 121 sequentially selects an image to be used for setting the group setting information from a plurality of images comprised in a group, which is the target for setup, in the following order. That is, the image recognizing module 121 sequentially selects the image starting from an image with the oldest image acquiring date and time contained in the metadata associated with the content ID.

Specifically, the image recognizing module 121 firstly determines the face ID associated with the face group ID in the group to be set in the object data table 500. The image recognizing module 121 then determines the content ID of detected image associated with the determined face ID in the object data table 500. Subsequently, the image recognizing module 121 determines that the images are sequentially used starting with the image determined with the content ID of detected image (the content ID) associated with the oldest image acquiring date and time, in the content data table 400 out of the determined content IDs of detected image (the content ID).

The image recognizing module 121 then determines whether the display setting associated with the content ID of detected image of the image to be used in the object data table 500 is set to “display” (S804). If the display setting associated with the content ID of detected image of the image to be used is set to “display” (Yes at S804), the image recognizing module 121 determines the group setting information so that display of the image is permitted, for the group to be set (S805).

If the display setting associated with the content ID of detected image of the image to be used is set to “hidden” (No at S804), the process sequence returns to S803 (S806). If the image recognizing module 121 executes the process at S804 for all of the images comprised in the group to be set, the process sequence proceeds to S807.

If the display setting stored with associated with the content ID of detected image of the image to be used is set to “hidden”, for all of the images comprised in the group to be set, the image recognizing module 121 determines the group setting information for the group to be set so that display of the image comprised in the group to be set is prohibited, according to the display setting of the image comprised in the group to be set.

If the processing at S804 is not executed for all of the images comprised in the group to be set, the process sequence in the image recognizing module 121 returns to S803 (S806), and the image recognizing module 121 determines the image comprising the subsequent older date and time on which the image is captured, comprised in the meta data associated with the content ID in the content data table 400, out of the images comprised in the group to be set, as the image to be used.

If the group setting information is set for all of the groups, the process sequence in the image recognizing module 121 ends the process for setting the group setting information. If the group setting information is not set for all of the groups, the process sequence returns to S801 (S807).

As described above, according to the information processor 100 in the embodiment, the image setting information (or the meta data) set for each image comprised in the groups after the regrouping process is treated as group setting information of the groups after the regrouping process, thereby dynamically changing the group setting information of the groups if the regrouping process is executed. This eliminates the necessity of resetting the group setting information on the groups if the regrouping process is executed.

In the description in the present embodiment, the image recognizing module 121 determines the information according to the display setting (the image setting information) that is an example of the setting information set in advance for the image comprised in the group to be set as the group setting information. However, this is provided merely for exemplary purpose and is not limiting. The image recognizing module 121 may determine the following information according to the setting information as the group setting information: the information indicating that printing the image is permitted or prohibited; the information indicating that printing characters of the image is permitted or prohibited; the information indicating whether a predetermined image process is executed when displaying the image; and the information indicating whether the image is set as a destination of a link.

The computer program executed in the information processor 100 according to the embodiment is recorded and provided in a computer-readable recording medium such as a compact disc read only memory (CD-ROM), a flexible disk (FD), a compact disc recordable (CD-R), and a digital versatile disc (DVD), as an installable or executable file.

The computer program executed in the information processor 100 in the embodiment may be stored in a computer connected to a network such as the Internet and provided by being downloaded via the network. Furthermore, the computer program executed in the information processor 100 according to the embodiment may be provided or distributed via a network such as the Internet.

The computer program executed in the information processor 100 in the embodiment has a module structure comprising the above-described components (the image recognizing module 121 and the image selection screen generator 122). In actual hardware, the CPU (processor) reads the computer program from the recording medium and executes the computer program. Once the computer program is executed, the above-described components are loaded into a main storage, so that the image recognizing module 121 and the image selection screen generator 122 are formed in the main storage.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for processing information using a processor, the method comprising:
regrouping images from at least a first group of first images and a second group of second images into a third group comprising at least one first image and at least one second image; and
setting third setting information for the third group based upon first setting information set for the first group and second setting information set for the second group.

2. The method for processing information of claim 1, wherein
the first setting information is set based on the at least one first image in the first group, and
the second setting information is set based on the at least one second image in the second group.

3. The method for processing information of claim 2, wherein
the first setting information comprises first information indicative of the at least one first image in the first group is permitted or prohibited to be displayed,
the second setting information comprises second information indicative of the at least one second image in the second group is permitted or prohibited to be displayed, and
the third setting information comprises third information indicative of the at least one first image or the at least one second image in the third group is permitted or prohibited to be displayed.

4. The method for processing information of claim 3, wherein, when a representative image of the third group is selected, one of the at least one first image and the at least one second image that is permitted to be displayed is displayed.

5. The method for processing information of claim 1, wherein the regrouping is based on at least one object in the at least one first image of the first group and at least one object in the at least one second image of the second group.

6. An information processor comprising:
a classifying controller configured to regroup images from at least a first group comprising first images and a second group comprising second images into a third group comprising at least one first image in the first group and at least one second image in the second group; and
a setting controller configured to set third setting information for the third group based on first setting information set for the first group and second setting information set for the second group.

7. The information processor of claim 6, wherein
the first setting information is set based on the at least one first image in the first group, and
the second setting information is set based on the at least one second image in the second group.

8. The information processor of claim 7, wherein
the first setting information is first information indicative of the at least one first image in the first group is permitted or prohibited to be displayed,
the second setting information is second information indicative of the at least one second image in the second group is permitted or prohibited to be displayed, and
the third setting information is third information indicative of the at least one first image or the at least one second image in the third group is permitted or prohibited to be displayed.

9. The information processor of claim 8, further comprising a display controller configured to display, when a representative image of the third group is selected, one of the at least one first image and the at least one second image that is permitted to be displayed.

10. The information processor of claim 7, wherein the classifying controller is configured to regroup the images based on at least one object in the at least one first image of the first group and at least one object in the at least one second image of the second group.

11. A computer program product having a non-transitory computer readable medium including programmed instructions, wherein the instructions, when executed by a computer, cause the computer to perform:
regrouping images from at least a first group comprising first images and a second group comprising second images into a third group comprising at least one first image in the first group and at least one second image in the second group; and
setting third setting information for the third group based upon first setting information set for the first group and second setting information set for the second group.

12. The computer program product of claim 11, wherein
the first setting information is set based on the at least one first image in the first group, and
the second setting information is set based on the at least one second image in the second group.

13. The computer program product of claim 12, wherein
the first setting information is first information indicative of the at least one first image in the first group is permitted or prohibited to be displayed,
the second setting information is second information indicative of the at least one second image in the second group is permitted or prohibited to be displayed, and
the third setting information is third information indicative of the at least one first image or at least one second image in the third group is permitted or prohibited to be displayed.

14. The computer program product of claim 13, wherein, when a representative image of the third group is selected, one of the at least one first image and the at least one second image that is permitted to be displayed is displayed.

15. The computer program product of claim 13, wherein the regrouping is based on at least one object in the at least one first image of the first group and at least one object in the at least one second image of the second group.
